(19) United States
(12) Patent Application Publication
(10) Pub. No.: US 2019/0114673 A1
(43) Pub. Date: Apr. 18, 2019

(54) DIGITAL EXPERIENCE TARGETING USING BAYESIAN APPROACH

(71) Applicant: Adobe Inc., San Jose, CA (US)

(72) Inventors: Piyush Gupta, Noida (IN); Nikaash Puri, New Delhi (IN); Balaji Krishnamurthy, Noida (IN)

(73) Assignee: AdobeInc., San Jose, CA (US)

(21) Appl. No.: 15/787,369

(22) Filed: Oct. 18, 2017

(51) Int. Cl. G06Q 30/02; G06N 7/00; G06N 5/02; G06N 3/02

(52) U.S. Cl. CPC G06Q 30/0269; G06N 7/005; G06Q 30/0242; G06N 3/02; G06N 5/022

(57) ABSTRACT

Digital experience targeting techniques are disclosed which serve digital experiences that have a high probability of conversion with regard to a given user visit profile. In some examples, a method may include predicting a probability of each digital experience in a campaign being served based on a user visit profile and an indication that a user exhibiting the user visit profile is going to convert, predicting a probability of each digital experience in the campaign being served based on the user visit profile and an indication that the user exhibiting the user visit profile is not going to convert, and deriving, for the user visit profile, a probability of conversion for each digital experience in the campaign. The probability of conversion for each digital experience in the campaign for the user visit profile may be derived using a Bayesian framework.

### FIELD OF THE DISCLOSURE

This disclosure relates generally to digital experiences, and more particularly, to digital experience targeting using a Bayesian approach.

### BACKGROUND

Digital experience spans the range of experiences that users have with an organization's communications, products, and processes over digital channels, such as websites, social media, mobile and tablet applications, and email, to name a few examples. The development of platforms, such as computers, tablets, smartphones, smartwatches, and the like, with which users can access the digital channels without regard to time and location provides a great opportunity for organizations to deliver information. An unfortunate consequence of the development of these digital channels and platforms is that users are being overwhelmed with an abundance of information.

### BRIEF DESCRIPTION OF THE DRAWINGS

The accompanying drawings are not intended to be drawn to scale. In the drawings, each identical or nearly identical component that is illustrated in various figures is represented by a like numeral, as will be appreciated when read in context.

FIG. 1 is a block diagram illustrating an example digital experience targeting framework, arranged in accordance with at least some embodiments described herein.

FIG. 2 is a diagram illustrating example training data inputs to a conversion multi-class classifier and a non-conversion multi-class classifier of the framework, in accordance with at least some embodiments described herein.

FIG. 3 is a diagram illustrating example inputs and outputs of the conversion multi-class classifier and the non-conversion multi-class classifier of the framework, in accordance with at least some embodiments described herein.

FIG. 4 is a flow diagram illustrating an example process to provide targeting of digital experiences having the highest probability of conversion, in accordance with at least some embodiments described herein.

FIG. 5 illustrates selected components of an example computing system that may be used to perform any of the techniques as variously described in the present disclosure, in accordance with at least some embodiments described herein.

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

### DETAILED DESCRIPTION

Organizations are being challenged to serve (e.g., show) users that visit their websites personalized digital experiences that will contribute towards maximizing returns for the organizations as a result of serving the digital experiences. In the context of conversions, the motivation for an organization is to select a digital experience to serve to a specific user that can help maximize the chance of that user converting (e.g., the user taking an action that is intended by the organization) when presented with the selected digital experience. For example, in the case of the digital experience being a webpage that includes an advertisement, the user converts (performs a conversion) on the digital experience by clicking or otherwise selecting the advertisement displayed in the webpage. Conversion by the user may be at the time of the digital experience being served to the user, or within a suitable period of time (e.g., 1 hour, 2 hours, etc.) after the digital experience is first served to the user. Similarly, the organization aims to serve the right digital experience to the right user. Intuitively, what this means is that a specific user should be served a digital experience that the user is most likely to convert on. For example, a financial institution may have two types of digital experiences (e.g., advertisements) in a campaign, one for platinum credit cards and the other for gold-limit credit cards. It may be the case that users from certain locations are more likely to prefer the platinum credit card than the gold-limit credit card, and vice versa. It is then the responsibility of the financial institution to determine which of the two digital experiences a new user is more likely to convert for, and then serve that digital experience to a new user.

Supervised machine learning classifiers can be trained and utilized to determine what digital experience to serve to a specific user. The data available to train the classifiers is of two types, conversion data and non-conversion data. Conversion data typically includes, for each user who converted for a particular digital experience, a user visit profile (e.g., attributes of the user) and an identifier of the particular digital experience the user converted for. Non-conversion data typically includes, for each user who did not convert for a particular digital experience, a user visit profile and an identifier of the particular digital experience the user did not convert for. A constraint is that the data available to train the classifier is incomplete. That is, there is no data with regards to what would have happened had a user been shown some other (different) digital experience. So, for instance, if the user did not convert for digital experience A, there is no training data with regards to what would have happened had the user been shown a digital experience B, or a digital experience C, and so on. This data (knowledge) is necessary to properly train a supervised machine learning classifier that can predict the best digital experience to serve a user when user visit profile attributes of the user are provided as input to the trained classifier. But, without the complete training data (complete knowledge), properly training such a classifier is very difficult.

One possible solution to account for the incomplete training data may be to train one classifier for each digital experience in a campaign. For instance, if a campaign included ten digital experiences, ten classifiers (a classifier for a specific digital experience) can be trained using the conversion data and non-conversion data for that particular digital experience. Each classifier can be trained to predict the likelihood of conversion given a user visit profile. Then, at serving time, an organization can query each classifier individually to determine a conversion likelihood of a particular user for the digital experience. The organization can then select the digital experience with the highest predicted probability of conversion for delivery to the particular user. When there are several digital experiences in the campaign, the organization needs to query several classifiers before the organization can make a determination as to the digital experience to serve. Unfortunately, when dealing with large numbers of digital experiences, querying a large number of classifiers can increase latency in serving the digital experience. Moreover, each classifier ignores the value of any pattern or patterns that may differentiate between the digital experiences in that each classifier is trained for a specific digital experience.

Another possible solution to account for the incomplete training data may be to train a multi-class classifier for the digital experiences in a campaign. The multi-class classifier can be trained using the conversion data for all the digital experiences in the campaign to predict, for a user visit profile, which digital experience a user of that user visit profile is likely to convert for. Unfortunately, the multi-class classifier trained in this manner can produce results that exhibit variance, maybe even significant variance. The variance may be due to the multi-class classifier being trained on a small training data set. That is, the conversion rate in a campaign is likely to be low, even very low. Hence, the number of conversion records as a fraction of the total number of total records is likely to be very small, which results in the multi-class classifier being trained on very little data and, as a result, more likely to exhibit variance in its results. One approach to correcting the variance issue may be to wait for a significant amount of time (e.g., after the campaign has started) to gather enough training data (e.g. conversion data) to train the multi-class classifier. Moreover, the multi-class classifier also completely ignores the value of the non-conversion data in determining which digital experience to serve to a user. It is possible that the non-conversion data may impart important information for deciding which digital experience to serve to the user. For example, it may be that 100 users from California converted when served digital experience A, while 50 users from California converted when served digital experience B. Using a multi-class classifier trained with this conversion data, the organization might erroneously conclude that users from California were more likely to convert for digital experience A than for digital experience B. However, the non-conversion data might show that 1,000 users from California did not convert when served digital experience A, while 50 users from California did not convert when served digital experience B. With this additional data (non-conversion data), it is quite clear that, in fact, users from California were more likely to convert when served digital experience B. This fact is overlooked by the multi-class classifier trained using only conversion data.

To this end, techniques are disclosed herein for a multi-class classifier framework to target digital experiences given the constraint of incomplete training data. The framework provides for the targeting of digital experiences that have high probability of conversion with regard to a given user visit profile (e.g., a user having or exhibiting the given user visit profile). In some embodiments, the multi-class classifier framework includes a conversion multi-class classifier, a non-conversion multi-class classifier, and a conversion likelihood estimator. The multi-class classifiers may be implemented using any suitable algorithm or mechanism capable of being trained to solve multi-class classification problems (e.g., capable of learning digital experience (class) specific probability), such as random forests, neural networks (e.g., feed forward neural networks), gradient boosted trees, support vector machines (SVMs), and decision trees, to name a few examples. The conversion multi-class classifier is trained using only the conversion data. The objective of the conversion multi-class classifier is to predict, for a given user visit profile, the probability of each digital experience in a campaign being served with regard to the given user visit profile and given that the digital experience for which the probability is predicted resulted in conversion. The non-conversion multi-class classifier is trained using only non-conversion data. The objective of the non-conversion multi-class classifier is to predict, for the given user visit profile, the probability of each digital experience in the campaign being served with regard to the given user visit profile and given that the digital experience for which the probability is predicted resulted in non-conversion (did not result in conversion). The conversion likelihood estimator combines the probabilities generated by the two multi-class classifiers, using a Bayes' theorem, to derive the probability of conversion for each digital experience in the campaign with regard to the given user visit profile. The digital experience to serve to a user exhibiting the given user visit profile is determined based on the derived probability of conversion for each digital experience with regard to the given user visit profile. For example, the digital experience having the highest ratio (ratio value) of the probability of conversion to the probability of non-conversion, with regards to the given user visit profile, can be selected as the digital experience that will have the highest probability of conversion if served to the user exhibiting the given user visit profile.

The foregoing framework provides one multi-class classifier trained using conversion data across all digital experiences in a campaign, and a second multi-class classifier trained using non-conversion data across all digital experiences in the campaign. That is, only two multi-class classifiers are trained, one for conversion data and the other for non-conversion data, regardless of the number of digital experiences in the campaign. Accordingly, at the time of serving the digital experience, only two multi-class classifiers are queried to decide on a digital experience to serve, thereby providing the ability to make quick decisions as to what digital experience to serve.

Moreover, as both conversion data and non-conversion data are used in training the two multi-class classifiers, the framework requires less time to collect the training data (the conversion data and the non-conversion data used to train the two multi-class classifiers). That is, as the entire training data set (the conversion data and the non-conversion data) is used to train the two multi-class classifiers, the two multi-class classifiers are trained with a sufficiently large amount of data. In addition, the framework is able to better derive a complete picture of user behavior since the framework incorporates both conversion as well as non-conversion data.

Furthermore, the framework utilizes two multi-class classifiers, which are trained using conversion data and non-conversion data, respectively, to determine the probabilities for all classes, where each class denotes a digital experience in a campaign. Determining the probabilities for all classes allows the two multi-class classifiers to learn patterns that differentiate between digital experiences. As a result, the framework is likely to give less weight to conversion data associated with generic patterns, such as “people from California are more likely to convert, regardless of the offer.” Rather, the framework is likely to give more weight to conversion data associated with distinguishing patterns, such as “iPhone users from California are likely to convert for offer X and not for offer Y.”

Framework

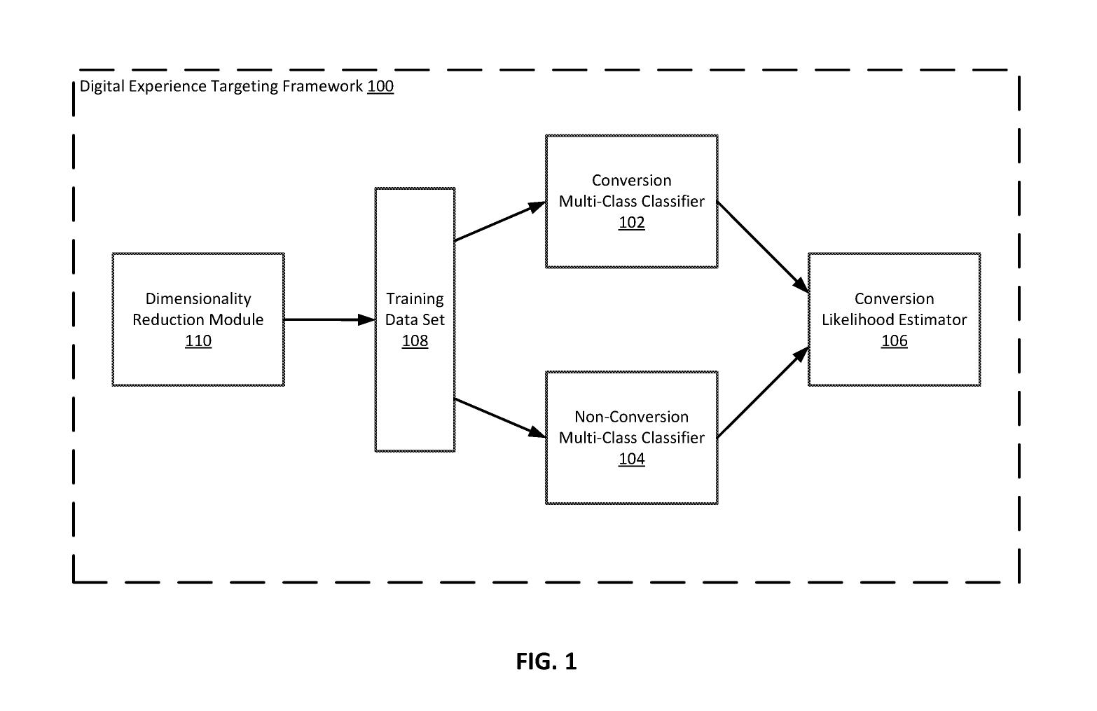

Turning now to the figures, FIG. 1 is a block diagram illustrating an example digital experience targeting framework 100, arranged in accordance with at least some embodiments described herein. Digital experience targeting framework 100 facilitates the selection of digital experiences that have high probability of conversion with regard to a given user visit profile, given the constraint of incomplete training data. As discussed above, the constraint of incomplete training data is that the conversion and non-conversion result (data) is known only for the digital experiences shown to users. Accordingly, digital experience targeting framework 100 may be utilized by organizations to provide personalized digital experiences to its users (consumers, visitors, etc.). As depicted, digital experience targeting framework 100 includes a conversion multi-class classifier 102, a non-conversion multi-class classifier 104, and a conversion likelihood estimator 106.

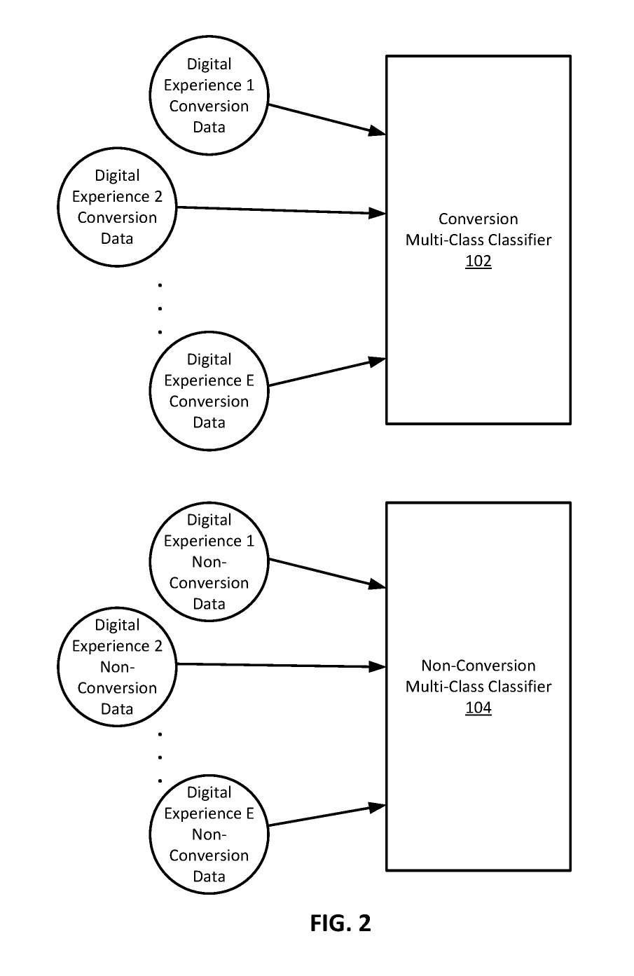

Conversion multi-class classifier 102 may be a multi-class classifier that, provided a given user visit profile, predicts, for each digital experience in a campaign, a probability of each digital experience being served with regard to the given user visit profile and given that the digital experience resulted in conversion. Non-conversion multi-class classifier 104 may be a multi-class classifier that, provided a given user visit profile as input, predicts, for each digital experience in a campaign, a probability of each digital experience being served with regard to the given user visit profile and given that the digital experience resulted in non-conversion. In some embodiments, each of conversion multi-class classifier 102 and non-conversion multi-class classifier 104 may be implemented using any suitable algorithm or mechanism capable of being trained to solve multi-class classification problems (e.g., capable of learning digital experience (class) specific probability), such as random forests, neural networks, gradient boosted trees, and decision trees, to name a few examples. Conversion multi-class classifier 102 and non-conversion classifier 104 are each trained to generate the respective predictions based on a training data set 108, for example, as illustrated in FIG. 2.

FIG. 2 is a diagram illustrating example training data inputs to conversion multi-class classifier 102 and non-conversion multi-class classifier 104 of framework 100, in accordance with at least some embodiments described herein. As depicted, conversion multi-class classifier 102 is trained using only conversion data for all digital experiences, for example, all digital experiences 1 to E, in a campaign. The conversion data may include identifiers for each of the digital experiences 1 to E, and data regarding attributes of each user (e.g., user visit profile) that converted, and the identifier of the digital experience that the user converted for. Non-conversion multi-class classifier 104 is trained using only non-conversion data for all digital experiences, for example, all digital experiences 1 to E, in the campaign. Similar to the conversion data, the non-conversion data may include identifiers for each of the digital experiences 1 to E, and data regarding attributes of each user (e.g., user visit profile) that did not convert, and the identifier of the digital experience that the user did not converted for. The specific number of digital experiences, E, included in the campaign is for illustration, and one skilled in the art will appreciate that the campaign may include a different number of digital experiences, including a small number or a very large number of digital experiences.

The attributes of the users (e.g., user visit profiles) indicate the user characteristics that were either receptive (e.g., conversion) or non-receptive (e.g., non-conversion) when served the digital experiences. Broadly speaking, these attributes indicate the traits of the users that were either receptive or non-receptive to the digital experiences and, thus, can be used to target digital experiences to users based on the traits of the users at the time of serving the digital experiences. As will be appreciated, these attributes can be demographic (e.g., race, economic status, gender, profession, occupation, level of income, level of education, etc.) and/or behavioral (e.g., browsing behavior, shopping behavior, purchase history, recent activity, etc.). For example, an organization may determine the browsing behavior of users who visit its website from current session variables (e.g., session creation time, session termination time, and the like), historical session variables, and cookies (e.g., a cookie that is created first time a user is made part of a campaign). Additionally or alternatively, an organization can determine the interests of users by monitoring the webpages a user views while on its website. For example, the organization can associate each webpage on its website with one or more interest areas. When a user visits a webpage on the website, the organization can note the webpages the user views, and make a determination as to the interests of the users based on the viewed webpages. For example, the interest of a user may be determined from the frequency and/or recency of views of webpages associated with each interest area by the user. Additionally or alternatively, an organization may determine user visit profile attributes from sources such as referring URLs, HTTP requests, the computing device used by the user to access the organization website (e.g., computing device vendor, computing device operating system, and screen resolution of the computing device display (e.g., browser application height and/or width), etc.), to name a few examples. In a more general sense, the user visit profile attributes can be determined from any number of sources, including third-party sources.

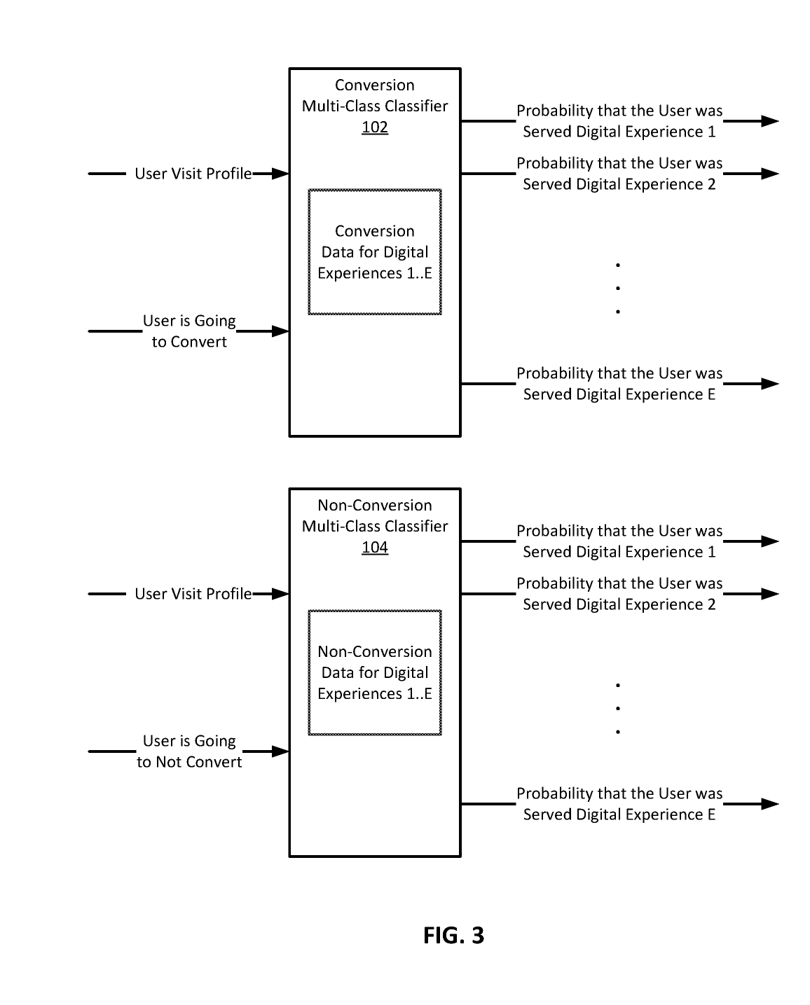

In some embodiments, conversion multi-class classifier 102 and non-conversion multi-class classifier 104 are trained periodically, for example, once every 12 hours, once every 24 hours, etc., using the collected conversion data and non-conversion data, respectively. For example, for every visit by a user (e.g., serving of a digital experience to a user), an organization can generate a visit record that includes an indication of a conversion status of the visit (i.e., the conversion data or the non-conversion data associated with the visit). The organization can collect and use the visit records to periodically train conversion multi-class classifier 102 and non-conversion multi-class classifier 104. The newly trained conversion multi-class classifier 102 and non-conversion multi-classifier 104 can be used in framework 100 until being replaced by conversion multi-class classifier 102 and non-conversion multi-class classifier 104 that are trained with newer (updated) training data. In some embodiments, conversion multi-class classifier 102 and non-conversion multi-class classifier 104 can be trained using conversion data and non-conversion data, respectively, collected over a preceding threshold number of days (a sliding window), for example, the preceding 30 days, the preceding 60 days, the preceding 90 days, and so on. In the instance a campaign is to be conducted (e.g., run) for an extended period of time, old or stale data may be gradually excluded from the training data (e.g., training data set 108) used to train conversion multi-class classifier 102 and non-conversion multi-class classifier 104. Conversely, at the start of a campaign, sufficient training data may not be available to adequately train conversion multi-class classifier 102 and non-conversion multi-class classifier 104. Moreover, a period of time in excess of the periodic training interval may be needed to collect the sufficient training data. In this instance, heuristics, such as waiting for a threshold number (e.g., 100, 150, etc.) of conversion data to be collected, may be applied in training conversion multi-class classifier 102 and non-conversion multi-class classifier 104. Once trained and provided the appropriate inputs, conversion multi-class classifier 102 and non-conversion classifier 104 are able to generate the respective predictions, for example, as illustrated in FIG. 3.

FIG. 3 is a diagram illustrating example inputs and outputs of conversion multi-class classifier 102 and non-conversion multiclass classifier 104 of framework 100, in accordance with at least some embodiments described herein. As described above, conversion multi-class classifier 102 is trained using only conversion data across all digital experiences 1 to E in a campaign, and non-conversion multi-class classifier 104 is trained using only non-conversion data across all digital experiences 1 to E in the campaign. Having being trained with the conversion data across all digital experiences 1 to E, conversion multi-class classifier 102 is able to predict the probability of each digital experience 1 to E being served for a given user visit profile that resulted in conversion. That is, as can be seen in FIG. 3, provided a user visit profile and provided that a user exhibiting the user visit profile is going to convert, conversion multi-class classifier generates a probability that the user was served digital experience 1, a probability that the user was served digital experience 2, . . . , and a probability that the user was served digital experience E. Similarly, having being trained with the non-conversion data across all digital experiences 1 to E, non-conversion multi-class classifier 104 is able to predict the probability of each digital experience 1 to E being served for a given user visit profile that resulted in non-conversion. That is, as can also be seen in FIG. 3, provided a user visit profile and provided that the user exhibiting the user visit profile is not going to convert, non-conversion multi-class classifier generates a probability that the user was served digital experience 1, a probability that the user was served digital experience 2, . . . , and a probability that the user was served digital experience E.

Referring again to FIG. 1, conversion likelihood estimator 106 is configured to derive a probability of conversion for each digital experience in a campaign with regard to a given user visit profile. In some embodiments, conversion likelihood estimator 106 combines the probabilities generated by conversion multi-class classifier 102 and non-conversion multi-class classifier 104 to derive the probability of conversion for each digital experience in the campaign for the given user visit profile. The probabilities generated by conversion multi-class classifier 102 and non-conversion multi-class classifier 104 may be combined using a Bayesian framework.

For example, suppose there are a total of k digital experiences, denoted as O₁, O₂, . . . , Oᵢ, . . . Oₖ. Also suppose C is the random variable that denotes conversion status, where C=1 denotes conversion, and C=0 denotes non-conversion. In this case, conversion multi-class classifier 102, trained using the conversion data across all digital experiences O₁, O₂, . . . , Oᵢ, . . . Oₖ, is predicting that, for the given user visit profile, when a user exhibiting the given user visit profile is known to be converted, the probability that the user was shown Oᵢ for all 1≤i≤k. This probability may be represented by P¹ᵢ=Pr(O=Oᵢ|C=1). Similarly, non-conversion multi-class classifier 104, trained using the non-conversion data across all digital experiences O₁, O₂, . . . , Oᵢ, . . . Oₖ, is predicting that, for the given user visit profile, when the user exhibiting the given user visit profile is known to be not converted, the probability that the user was shown Oᵢ for all 1≤i≤k. This probability may be represented by P²ᵢ=Pr(O=Oᵢ|C=0). Conversion likelihood estimator 106 may then derive the probability of conversion for the given user visit profile for digital experience Oᵢ using a Bayes' theorem as shown in equation [1] below.

$$\begin{matrix}Pr ( C = 1 \vert O = {O}_{i} ) = Pr ( O = {O}_{i} \vert C = 1 ) * \\ Pr ( C = 1 ) / [ Pr ( O = {O}_{i} \vert C = 1 ) * \\ Pr ( C = 1 ) + Pr ( O = {O}_{i} \vert C = 0 ) * Pr ( C = 0 ) ] \\ = 1 / [ 1 + ( {P}_{i}^{2} * ( 1 - Pr ( C = 1 ) ) ) / ( {P}_{i}^{1} * Pr ( C = 1 ) ) ]\end{matrix} \qquad [ 1 ]$$

From equation [1], conversion likelihood estimator 106 can determine that the digital experience that has the highest value of Pr(C=1|O=Oᵢ) will have the highest value of P¹ᵢ/P²ᵢ (the highest ratio of the probability of conversion to the probability of non-conversion). This is because the probability of conversion for a given user visit profile Pr(C=1) is independent of the digital experience served. Accordingly, to maximize the overall conversion rate, conversion likelihood estimator 106 may select the digital experience that is predicted to have the highest conversion probability corresponding to the given user visit profile for serving to the user exhibiting the given user visit profile.

In some embodiments, digital experience targeting framework 100 may optionally include a dimensionality reduction module 110 configured to reduce the dimensionality of the training data for use in training conversion multi-class classifier 102 and non-conversion multi-class classifier 104. Dimensionality reduction module 110 may use an unsupervised statistical technique, such as principal component analysis (PCA), over the training data to reduce the dimensionality of the training data. For example, reducing the dimensionality of the training data may be beneficial in instances where the large number of weights, due to the high dimensionality of the training data, can potentially lead to overfitting by conversion multi-class classifier 102 and non-conversion multi-class classifier 104 (e.g., in instances where conversion multi-class classifier 102 and non-conversion multi-class classifier 104 are implemented using neural networks).

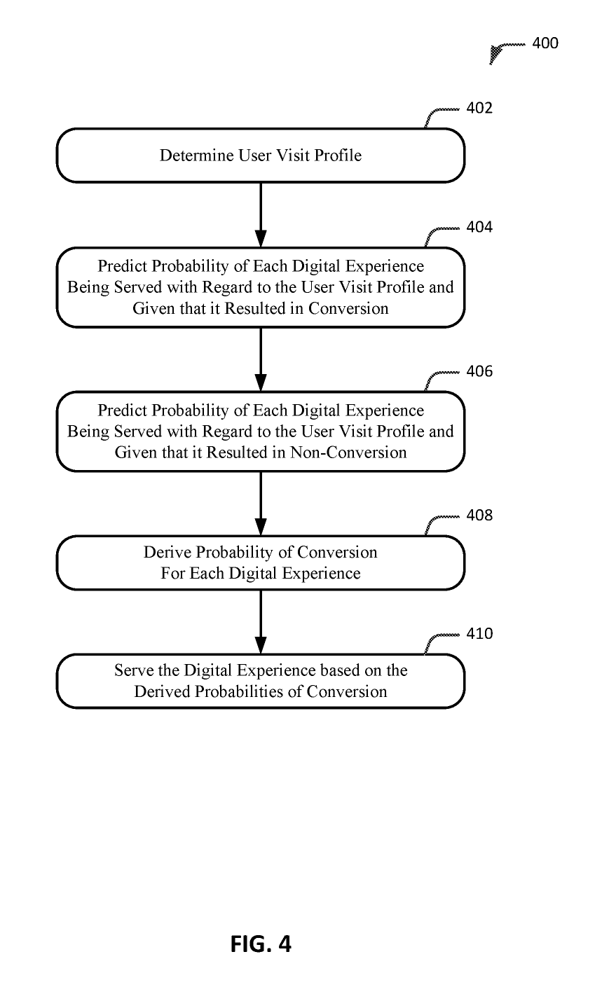

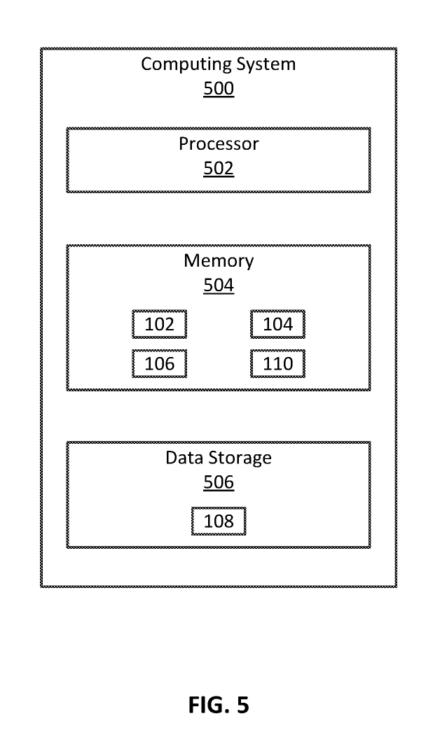

FIG. 4 is a flow diagram 400 illustrating an example process to provide targeting of digital experiences having the highest probability of conversion, in accordance with at least some embodiments described herein. Example processes and methods may include one or more operations, functions or actions as illustrated by one or more of blocks 402, 404, 406, 408, and/or 410, and may in some embodiments be performed by a computing system such as a computing system 500 of FIG. 5. The operations described in blocks 402-410 may also be stored as computer-executable instructions in a computer-readable medium, such as a memory 504 and/or a data storage 506 of computing system 500. The process may be performed by components of digital experience targeting framework 100.

As depicted by flow diagram 400, the process may begin with block 402, where a profile of a user visiting a website is determined. By way of an example use case, a user may be executing a client application, such as a browser application, on a computing device, and using the client application to visit (e.g., browse) an organization website. The organization (e.g., the organization website), having detected the presence of the user on its web site, can utilize digital experience targeting framework 100 to target to the user digital experiences in a campaign that have high probability of conversion by the user. Digital experience targeting framework 100 can determine the user visit profile (attributes of the user) from sources such as the browsing behavior of the user while visiting the website, historical session variables from prior visits of the user to the website, and cookies on the client application being utilized by the user to visit the website, to name a few examples.

Block 402 may be followed by block 404, where a probability of each digital experience in the campaign being served with regard to the user visit profile and given that the digital experience resulted in conversion is predicted. Continuing the example above, conversion multi-class classifier 102 can predict, provided the user visit profile of the user visiting the website, a probability of each digital experience in the campaign being served with regard to the provided user visit profile and given that the digital experience resulted in conversion.

Block 404 may be followed by block 406, where a probability of each digital experience in the campaign being served with regard to the user visit profile and given that the digital experience resulted in non-conversion is predicted. Continuing the example above, non-conversion multi-class classifier 104 can predict, provided the user visit profile of the user visiting the website, a probability of each digital experience in the campaign being served with regard to the provided user visit profile and given that the digital experience resulted in non-conversion.

Block 406 may be followed by block 408, where a probability of conversion for each digital experience in the campaign is derived. Continuing the example above, conversion likelihood estimator 106 can combine the probabilities generated by conversion multi-class classifier 102 and non-conversion multi-class classifier 104 to derive the probability of conversion for each digital experience in the campaign for the user visit profile of the user visiting the website. In some embodiments, conversion likelihood estimator 106 can combine the probabilities using a Bayesian framework.

Block 408 may be followed by block 410, where a digital experience is served based on the derived probabilities of conversion. Continuing the example above, conversion likelihood estimator 106 can select the digital experience in the campaign that is predicted to have the highest conversion probability corresponding to the user visit profile of the user visiting the website to be served to the user visiting the website. The organization (e.g., the organization website) can then serve the digital experience selected by conversion likelihood estimator 106 to the user visiting the website.

Those skilled in the art will appreciate that, for this and other processes and methods disclosed herein, the functions performed in the processes and methods may be implemented in differing order. Additionally or alternatively, two or more operations may be performed at the same time. Furthermore, the outlined actions and operations are only provided as examples, and some of the actions and operations may be optional, combined into fewer actions and operations, or expanded into additional actions and operations without detracting from the essence of the disclosed embodiments.

FIG. 5 illustrates selected components of example computing system 500 that may be used to perform any of the techniques as variously described in the present disclosure, in accordance with at least some embodiments described herein. In some embodiments, computing system 500 may be configured to implement or direct one or more operations associated with some or all of the engines, components and/or modules associated with digital experience targeting framework 100 of FIG. 1. For example, conversion multi-class classifier 102, non-conversion multi-class classifier 104, conversion likelihood estimator 106, training data 108, dimensionality reduction module 110, or any combination of these may be implemented in and/or using computing system 500. In one example case, for instance, each of conversion multi-class classifier 102, non-conversion multi-class classifier 104, conversion likelihood estimator 106, and dimensionality reduction module 110 is loaded in memory 504 and executable by a processor 502, and training data 108 is included in data storage 506. Computing system 500 may be any computer system, such as a workstation, desktop computer, server, laptop, handheld computer, tablet computer (e.g., the iPad™ tablet computer), mobile computing or communication device (e.g., the iPhone™ mobile communication device, the Android™ mobile communication device, and the like), or other form of computing or telecommunications device that is capable of communication and that has sufficient processor power and memory capacity to perform the operations described in this disclosure. A distributed computational system may be provided that includes a multiple of such computing devices. As depicted, computing system 500 may include processor 502, memory 504, and data storage 506. Processor 502, memory 504, and data storage 506 may be communicatively coupled.

In general, processor 502 may include any suitable special-purpose or general-purpose computer, computing entity, or computing or processing device including various computer hardware, firmware, or software modules, and may be configured to execute instructions, such as program instructions, stored on any applicable computer-readable storage media. For example, processor 502 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, processor 502 may include any number of processors and/or processor cores configured to, individually or collectively, perform or direct performance of any number of operations described in the present disclosure. Additionally, one or more of the processors may be present on one or more different electronic devices, such as different servers.

In some embodiments, processor 502 may be configured to interpret and/or execute program instructions and/or process data stored in memory 504, data storage 506, or memory 504 and data storage 506. In some embodiments, processor 502 may fetch program instructions from data storage 506 and load the program instructions in memory 504. After the program instructions are loaded into memory 504, processor 502 may execute the program instructions.

For example, in some embodiments, any one or more of the engines, components and/or modules of digital experience targeting framework 100 may be included in data storage 506 as program instructions. Processor 502 may fetch some or all of the program instructions from data storage 506 and may load the fetched program instructions in memory 504. Subsequent to loading the program instructions into memory 504, processor 502 may execute the program instructions such that the computing system may implement the operations as directed by the instructions.

In some embodiments, virtualization may be employed in computing device 500 so that infrastructure and resources in computing device 500 may be shared dynamically. For example, a virtual machine may be provided to handle a process running on multiple processors so that the process appears to be using only one computing resource rather than multiple computing resources. Multiple virtual machines may also be used with one processor.

Memory 504 and data storage 506 may include computer-readable storage media for carrying or having computer-executable instructions or data structures stored thereon. Such computer-readable storage media may include any available media that may be accessed by a general-purpose or special-purpose computer, such as processor 502. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 502 to perform a certain operation or group of operations.

Modifications, additions, or omissions may be made to computing system 500 without departing from the scope of the present disclosure. For example, in some embodiments, computing system 500 may include any number of other components that may not be explicitly illustrated or described herein.

As indicated above, the embodiments described in the present disclosure may include the use of a special purpose or a general purpose computer (e.g., processor 502 of FIG. 5) including various computer hardware or software modules, as discussed in greater detail herein. Further, as indicated above, embodiments described in the present disclosure may be implemented using computer-readable media (e.g., memory 504 of FIG. 5) for carrying or having computer-executable instructions or data structures stored thereon.

Numerous example variations and configurations will be apparent in light of this disclosure. According to some examples, systems to provide targeting of digital experiences having high probability of conversion are described. An example system may include: one or more processors; a conversion multi-class classifier at least one of controllable and executable by the one or more processors, the conversion multi-class classifier having a first input to receive a user visit profile and a second input to receive an indication that a user exhibiting the user visit profile is going to convert, the conversion multi-class classifier configured to predict a probability of each digital experience in a campaign being served; a non-conversion multi-class classifier at least one of controllable and executable by the one or more processors, the non-conversion multi-class classifier having a first input to receive the user visit profile and a second input to receive an indication that the user exhibiting the user visit profile is not going to convert, the non-conversion multi-class classifier configured to predict a probability of each digital experience in the campaign being served; and a conversion likelihood estimator at least one of controllable and executable by the one or more processors, and configured to derive, for the user visit profile and based on the probabilities generated by the conversion multi-class classifier and the non-conversion multi-class classifier, a probability of conversion for each digital experience in the campaign.

In some examples, the conversion likelihood estimator is configured to mathematically combine the probabilities generated by the conversion multi-class classifier and the non-conversion multi-class classifier to derive the probability of conversion for each digital experience in the campaign. In other examples, to combine the probabilities generated by the conversion multi-class classifier and the non-conversion multi-class classifier includes use of a Bayes' theorem. In still other examples, the conversion multi-class classifier is trained using only conversion data for digital experiences in the campaign. In yet other examples, the non-conversion multi-class classifier is trained using only non-conversion data for digital experiences in the campaign. In still further examples, the conversion multi-class classifier and the non-conversion multi-class classifier are each implemented using random forests. In other examples, the conversion multi-class classifier and the non-conversion multi-class classifier are each implemented using neural networks. In still other examples, the conversion multi-class classifier and the non-conversion multi-class classifier are each implemented using gradient boosted trees. In yet other examples, the conversion multi-class classifier and the non-conversion multi-class classifier are each implemented using decision trees. In further examples, the system further includes a dimensionality reduction module at least one of controllable and executable by the one or more processors, and configured to reduce dimensionality of training data for use in training the conversion multi-class classifier and the non-conversion multi-class classifier.

According to some examples, computer-implemented methods to provide targeting of digital experiences having high probability of conversion are described. An example computer-implemented method may include: predicting, by a conversion multi-class classifier based on a first input to receive a user visit profile and a second input to receive an indication that a user exhibiting the user visit profile is going to convert, a probability of each digital experience in a campaign being served; predicting, by a non-conversion multi-class classifier and based on a first input to receive the user visit profile and a second input to receive an indication that the user exhibiting the user visit profile is not going to convert, a probability of each digital experience in the campaign being served; and deriving, by a conversion likelihood estimator for the user visit profile and based on the probabilities generated by the conversion multi-class classifier and the non-conversion multi-class classifier, a probability of conversion for each digital experience in the campaign.

In some examples, deriving the probability of conversion for each digital experience in the campaign includes mathematically combining, using a Bayes' theorem, the probabilities generated by the conversion multi-class classifier and the non-conversion multi-class classifier. In other examples, the method may also include: training the conversion multi-class classifier using only conversion data for digital experiences in the campaign; and training the non-conversion multi-class classifier using only non-conversion data for digital experiences in the campaign. In still other examples, the conversion multi-class classifier and the non-conversion multi-class classifier are each implemented using one of random forests, neural networks, gradient boosted trees, and decision trees. In yet other examples, the method may further include reducing dimensionality of training data for use in training the conversion multi-class classifier and the non-conversion multi-class classifier.

According to some examples, computer program products including one or more non-transitory machine readable media encoded with instructions that when executed by one or more processors cause a process of providing targeting of digital experiences having high probability of conversion to be carried out are described. An example process may include: predicting, based on a user visit profile and an indication that a user exhibiting the user visit profile is going to convert, a probability of each digital experience in a campaign being served; predicting, based on the user visit profile and an indication that the user exhibiting the user visit profile is not going to convert, a probability of each digital experience in the campaign being served; and deriving, for the user visit profile, a probability of conversion for each digital experience in the campaign.

In some examples, the probability of each digital experience in the campaign being served based on the user visit profile and the indication that a user exhibiting the user visit profile is going to convert being generated using a conversion multi-class classifier, and the probability of each digital experience in the campaign being served based on the user visit profile and the indication that the user exhibiting the user visit profile is not going to convert being generated using a non-conversion multi-class classifier, the conversion multi-class classifier being distinct from the non-conversion multi-class classifier. In still other examples, the conversion multi-class classifier being trained using only conversion data for digital experiences in the campaign, and the non-conversion multi-class classifier being trained using only non-conversion data for digital experiences in the campaign. In further examples, the conversion multi-class classifier and the non-conversion multi-class classifier are each implemented using one of random forests, neural networks, gradient boosted trees, and decision trees. In still further examples, deriving the probability of conversion for each digital experience in the campaign includes mathematically combining, using a Bayes' theorem, the probabilities generated by the conversion multi-class classifier and the non-conversion multi-class classifier.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A system to provide targeting of digital experiences having high probability of conversion, the system comprising:
one or more processors;
a conversion multi-class classifier at least one of controllable and executable by the one or more processors, the conversion multi-class classifier having a first input to receive a user visit profile and a second input to receive an indication that a user exhibiting the user visit profile is going to convert, the conversion multi-class classifier configured to predict a probability of each digital experience in a campaign being served;
a non-conversion multi-class classifier at least one of controllable and executable by the one or more processors, the non-conversion multi-class classifier having a first input to receive the user visit profile and a second input to receive an indication that the user exhibiting the user visit profile is not going to convert, the non-conversion multi-class classifier configured to predict a probability of each digital experience in the campaign being served; and
a conversion likelihood estimator at least one of controllable and executable by the one or more processors, and configured to derive, for the user visit profile and based on the probabilities generated by the conversion multi-class classifier and the non-conversion multi-class classifier, a probability of conversion for each digital experience in the campaign.

2. The system of claim 1, wherein the conversion likelihood estimator is configured to mathematically combine the probabilities generated by the conversion multi-class classifier and the non-conversion multi-class classifier to derive the probability of conversion for each digital experience in the campaign.

3. The system of claim 2, wherein to combine the probabilities generated by the conversion multi-class classifier and the non-conversion multi-class classifier includes use of a Bayes' theorem.

4. The system of claim 1, wherein the conversion multi-class classifier is trained using only conversion data for digital experiences in the campaign.

5. The system of claim 1, wherein the non-conversion multi-class classifier is trained using only non-conversion data for digital experiences in the campaign.

6. The system of claim 1, wherein the conversion multi-class classifier and the non-conversion multi-class classifier are each implemented using random forests.

7. The system of claim 1, wherein the conversion multi-class classifier and the non-conversion multi-class classifier are each implemented using neural networks.

8. The system of claim 1, wherein the conversion multi-class classifier and the non-conversion multi-class classifier are each implemented using gradient boosted trees.

9. The system of claim 1, wherein the conversion multi-class classifier and the non-conversion multi-class classifier are each implemented using decision trees.

10. The system of claim 1, further comprising a dimensionality reduction module at least one of controllable and executable by the one or more processors, and configured to reduce dimensionality of training data for use in training the conversion multi-class classifier and the non-conversion multi-class classifier.

11. A computer-implemented method to provide targeting of digital experiences having high probability of conversion, the method comprising:
predicting, by a conversion multi-class classifier based on a first input to receive a user visit profile and a second input to receive an indication that a user exhibiting the user visit profile is going to convert, a probability of each digital experience in a campaign being served;
predicting, by a non-conversion multi-class classifier and based on a first input to receive the user visit profile and a second input to receive an indication that the user exhibiting the user visit profile is not going to convert, a probability of each digital experience in the campaign being served; and
deriving, by a conversion likelihood estimator for the user visit profile and based on the probabilities generated by the conversion multi-class classifier and the non-conversion multi-class classifier, a probability of conversion for each digital experience in the campaign.

12. The method of claim 11, wherein deriving the probability of conversion for each digital experience in the campaign includes mathematically combining, using a Bayes' theorem, the probabilities generated by the conversion multi-class classifier and the non-conversion multi-class classifier.

13. The method of claim 11, further comprising:
training the conversion multi-class classifier using only conversion data for digital experiences in the campaign; and
training the non-conversion multi-class classifier using only non-conversion data for digital experiences in the campaign.

14. The method of claim 11, wherein the conversion multi-class classifier and the non-conversion multi-class classifier are each implemented using one of random forests, neural networks, gradient boosted trees, and decision trees.

15. The method of claim 11, further comprising reducing dimensionality of training data for use in training the conversion multi-class classifier and the non-conversion multi-class classifier.

16. A computer program product including one or more non-transitory machine readable media encoded with instructions that when executed by one or more processors cause a process of providing targeting of digital experiences having high probability of conversion to be carried out, the process comprising:
predicting, based on a user visit profile and an indication that a user exhibiting the user visit profile is going to convert, a probability of each digital experience in a campaign being served;
predicting, based on the user visit profile and an indication that the user exhibiting the user visit profile is not going to convert, a probability of each digital experience in the campaign being served; and
deriving, for the user visit profile, a probability of conversion for each digital experience in the campaign.

17. The computer program product of claim 16, wherein the probability of each digital experience in the campaign being served based on the user visit profile and the indication that a user exhibiting the user visit profile is going to convert being generated using a conversion multi-class classifier, and the probability of each digital experience in the campaign being served based on the user visit profile and the indication that the user exhibiting the user visit profile is not going to convert being generated using a non-conversion multi-class classifier, the conversion multi-class classifier being distinct from the non-conversion multi-class classifier.

18. The computer program product of claim 17, wherein the conversion multi-class classifier being trained using only conversion data for digital experiences in the campaign, and the non-conversion multi-class classifier being trained using only non-conversion data for digital experiences in the campaign.

19. The computer program product of claim 17, wherein the conversion multi-class classifier and the non-conversion multi-class classifier are each implemented using one of random forests, neural networks, gradient boosted trees, and decision trees.

20. The computer program product of claim 17, wherein deriving the probability of conversion for each digital experience in the campaign includes mathematically combining, using a Bayes' theorem, the probabilities generated by the conversion multi-class classifier and the non-conversion multi-class classifier.
